(19) United States
(12) Patent Application Publication
(10) Pub. No.: US 2025/0224240 A1
(43) Pub. Date: Jul. 10, 2025

(54) TRANSPORT ROUTE PRESENTATION APPARATUS, TRANSPORT ROUTE PRESENTATION METHOD, AND NON-TRANSITORY COMPUTER-READABLE MEDIUM

(71) Applicant: NEC Corporation, Minato-ku, Tokyo (JP)

(72) Inventors: Hitomi ITO, Tokyo (JP); Yoko Tanaka, Tokyo (JP); Masaru Yanai, Tokyo (JP); Kosel Kobayashi, Tokyo (JP); Sawaka Seki, Tokyo (JP)

(73) Assignee: NEC Corporation, Minato-ku, Tokyo (JP)

(21) Appl. No.: 18/854,585

(22) PCT Filed: Mar. 16, 2022
(86) PCT No.: PCT/JP2022/012014

§ 371 Date: Oct. 7, 2024

(51) Int. Cl. G01C 21/34; G01C 21/36

(52) U.S. Cl. CPC G01C 21/3461; G01C 21/3492; G01C 21/3602; G01C 21/3617; G01C 21/3647; G01C 21/3691

(57) ABSTRACT

An object of the present disclosure is to provide a transport route presentation apparatus capable of presenting a transport route in accordance with detailed symptoms of a patient. In the transport route presentation apparatus, a patient information acquisition unit acquires medical condition information of a patient. A route search unit searches for a plurality of transport routes along which the patient is transported to a transport destination. A route evaluation unit evaluates a burden on a patient and a required time for each of the plurality of transport routes. A route priority determination unit determines a priority for each of the plurality of transport routes based on the medical condition information of the patient, the burden, and the required time. A route presentation unit presents at least one of the plurality of transport routes in accordance with the priority.

### TECHNICAL FIELD

The present disclosure relates to a transport route presentation apparatus, a transport route presentation method, and a non-transitory computer-readable medium.

### BACKGROUND ART

Patent Literature 1 discloses a technique for drafting a pick-up plan in consideration of a physical condition of a pick-up subject. Specifically, according to the technique, vital information is acquired from one or a plurality of pick-up target persons, and a pick-up route is set based on the acquired vital information. In the technique, for example, in order to inhibit occurrence of a poor physical condition, a pick-up route is set by prioritizing a road where rapid acceleration in the left and right directions is less likely and that has a straighter form than a road that is sharply curved or a winding road.

### CITATION LIST

### Patent Literature Patent Literature 1: Japanese Unexamined Patent Application Publication No. 2021-157656

### SUMMARY OF INVENTION

### Technical Problem

However, in Patent Literature 1, there is a problem that a transport route appropriate for detailed symptoms of a patient cannot be presented since the transport route (pick-up route) is presented only based on two types of references that a physical condition of the patient (pick-up subject) is normal or bad. For example, not only a transport route prioritizing a reduction of a burden on the patient who is being transported but also a transport route prioritizing a reduction of a required time for transport may be required depending on the symptoms of the patient.

In view of such a problem, an object of the present disclosure is to provide a transport route presentation apparatus, a transport route presentation method, and a non-transitory computer-readable medium capable of presenting a transport route depending on detailed symptoms of a patient.

### Solution to Problem

According to an aspect of the present disclosure, a transport route presentation apparatus includes:
a patient information acquisition unit configured to acquire medical condition information of a patient;
a route search unit configured to search for a plurality of transport routes along which the patient is transported to a transport destination;
a route evaluation unit configured to evaluate a burden on a patient and a required time for each of the plurality of transport routes;
a route priority determination unit configured to determine a priority for each of the plurality of transport routes based on the medical condition information of the patient, the burden, and the required time; and
a route presentation unit configured to present at least one of the plurality of transport routes in accordance with the priority.

According to another aspect of the present disclosure, a transport route presentation method causes a computer to perform:
acquiring medical condition information of a patient;
searching for a plurality of transport routes along which the patient is transported to a transport destination;
evaluating a burden on a patient and a required time for each of the plurality of transport routes;
determining a priority for each of the plurality of transport routes based on the medical condition information of the patient, the burden, and the required time; and
presenting at least one of the plurality of transport routes in accordance with the priority.

According to still another aspect of the present disclosure, a non-transitory computer-readable medium stores a program causing a computer to perform:
acquiring medical condition information of a patient;
searching for a plurality of transport routes along which the patient is transported to a transport destination;
evaluating a burden on a patient and a required time for each of the plurality of transport routes;
determining a priority for each of the plurality of transport routes based on the medical condition information of the patient, the burden, and the required time; and
presenting at least one of the plurality of transport routes in accordance with the priority.

### Advantageous Effects of Invention

According to the present disclosure, it is possible to provide a transport route presentation apparatus, a transport route presentation method, and a non-transitory computer-readable medium capable of presenting a transport route depending on detailed symptoms of a patient.

### BRIEF DESCRIPTION OF DRAWINGS

FIG. 1 is a block diagram illustrating a configuration of a transport route presentation apparatus according to a first example embodiment.

FIG. 2 is a block diagram illustrating a configuration of a transport route presentation system according to a second example embodiment.

FIG. 3 is a flowchart illustrating an operation of the transport route presentation apparatus according to the second example embodiment.

FIG. 4 is a table illustrating an example of a method of determining a priority of a transport route in the transport route presentation apparatus according to the second example embodiment.

FIG. 5 is a block diagram illustrating a configuration of a computer according to the first and second example embodiments.

### EXAMPLE EMBODIMENT

Hereinafter, example embodiments of the present disclosure will be described in detail with reference to the drawings. In the drawings, the same or corresponding elements are denoted by the same reference numerals and signs, and repeated description of the elements will be omitted according to necessity for clarity of description.

### First Example Embodiment

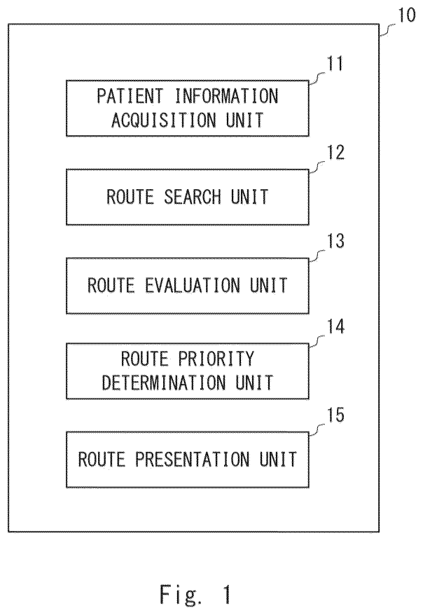

First, a configuration of a transport route presentation apparatus 10 according to a first example embodiment will be described with reference to FIG. 1.

The transport route presentation apparatus 10 includes a patient information acquisition unit 11, a route search unit 12, a route evaluation unit 13, a route priority determination unit 14, and a route presentation unit 15.

The patient information acquisition unit 11 acquires medical condition information of a patient. The route search unit 12 searches for a plurality of transport routes along which the patient is transported to the transport destination. The route evaluation unit 13 evaluates a burden on the patient and a required time for each of the plurality of transport routes. The route priority determination unit 14 determines a priority for each of the plurality of transport routes based on the medical condition information of the patient, the burden, and the required time. The route presentation unit 15 presents at least one of the plurality of transport routes in accordance with the priority.

The transport route presentation apparatus 10 according to the first example embodiment can present a transport route in accordance with detailed symptoms of the patient. For example, the transport route presentation apparatus 10 can prioritize not only a transport route in which a burden on the patient during transport is small depending on the symptoms of the patient, but also a transport route in which a time required for transport is short.

### Second Example Embodiment

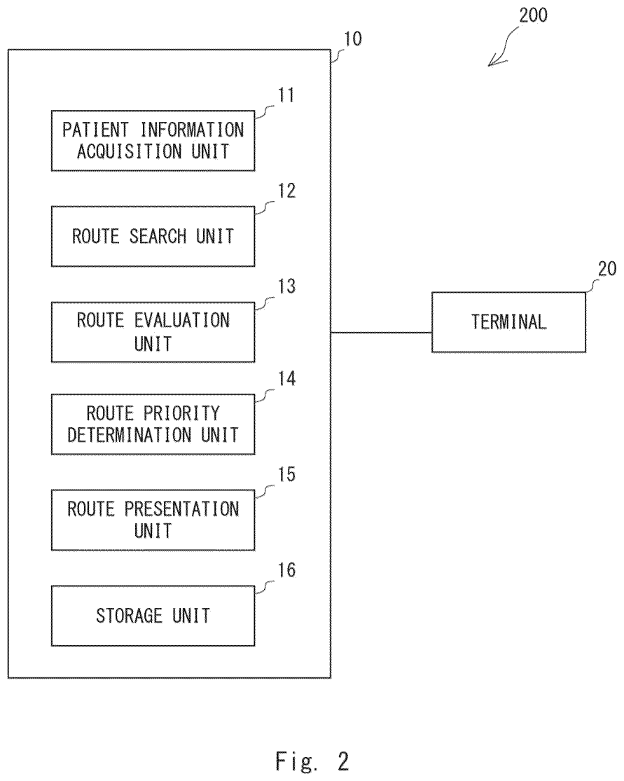

Next, a configuration of a transport route presentation system 200 according to a second example embodiment will be described with reference to FIG. 2. The transport route presentation system 200 includes a transport route presentation apparatus 10 and a terminal 20.

The transport route presentation apparatus 10 is an apparatus that presents, to the terminal 20, a transport route along which a sick patient is transported to a transport destination. The transport destination is, for example, a medical facility such as a hospital. As the transport route to be provided, a route in a case where a vehicle is used for transportation is assumed. However, walking may be used for transportation.

The transport route presentation apparatus 10 is a server (for example, a server constructed on a cloud) and communicates with the terminal 20 via a network.

The terminal 20 is, for example, a terminal used by an ambulance attendant who supports a patient. The terminal 20 is a terminal such as a tablet, a smartphone, or a notebook computer. The terminal 20 may be a dedicated terminal. The terminal 20 may be used by a person other than an ambulance attendant or may be used by a patient himself or herself or a person in a facility that manages a transport vehicle.

The transport route presentation apparatus 10 includes a patient information acquisition unit 11, a route search unit 12, a route evaluation unit 13, a route priority determination unit 14, a route presentation unit 15, and a storage unit 16.

The patient information acquisition unit 11 acquires medical condition information of a patient from the terminal 20. The medical condition information of the patient indicates a medical condition of the patient, a medical condition level, and the like, such as an external injury (light) and an external injury (heavy).

The route search unit 12 searches for a plurality of transport routes along which the patient is transported to the transport destination. Specifically, the route search unit 12 searches for a plurality of transport routes along which the patient is transported to a transport destination based on current positional information of the patient and the map information. For example, the current positional information of the patient is information regarding a current position of the patient input to the terminal 20 by an emergency attendant or the like, Global Positioning System (GPS) information of the terminal 20, or the like and is acquired from the terminal 20. The map information is map information of an area including a transport source and a transport destination and is stored in advance in the storage unit 16.

The route evaluation unit 13 evaluates a burden on the patient and a required time for each of the plurality of transport routes. The burden on the patient is obtained by evaluating how much of a burden is applied to the patient during transport. The required time is a time required from the transport source, that is, the current position of the patient to the transport destination. The required time is evaluated as a time measured when a vehicle is used to transport the patient, but may be evaluated as a time measured when walking is used to transport the patient.

Specifically, the route evaluation unit 13 calculates a burden and a required time based on a distance from the transport source to the transport destination.

The route evaluation unit 13 acquires topographic information of a road from an external apparatus at a predetermined interval and stores the topographic information in the storage unit 16. The topographic information of the road is information indicating a sharp curve, a step, a gradient, and the like on the road. For example, the topographic information of the road is information based on acceleration information of the vehicle acquired from the vehicle and positional information of the vehicle. Here, a position at which the acceleration is larger than a predetermined threshold on the road is determined to be a position at which there is a sharp curve, a step, or a gradient. The route evaluation unit 13 evaluates the burden and the required time for each of the transport routes based on the topographic information of the road acquired at a predetermined interval. For example, the route evaluation unit 13 evaluates that the more the route passes through a sharp curve, a step, or a gradient along the transport route, the larger the burden and the longer the required time are.

The route evaluation unit 13 also acquires weather information from an external apparatus at a predetermined interval and stores the weather information in the storage unit 16. The route evaluation unit 13 evaluates the burden and the required time for each of the transport routes based on the weather information acquired at the predetermined interval. For example, the route evaluation unit 13 evaluates that the worse the weather is, such as with heavy rain or snow, the higher the burden and the required time are.

The route evaluation unit 13 acquires congestion information of the road from an external apparatus and stores the congestion information of the road in the storage unit 16. The congestion information of the road is information based on at least one of imaging information acquired from an imaging apparatus installed on the road and information regarding a traffic light installed on the road. The route evaluation unit 13 evaluates the burden and the required time for each of the transport routes based on the congestion information of the road acquired at a predetermined interval. For example, the route evaluation unit 13 evaluates that the heavier the road is, the longer the required time is.

The route priority determination unit 14 determines a priority for each of the plurality of transport routes based on the medical condition information of the patient, the burden, and the required time.

Specifically, the route priority determination unit 14 evaluates an urgency level and a rest level of the medical condition of the patient based on the medical condition information of the patient. The urgency level indicates how urgent a medical condition of a patient is. As the urgency level increases, the medical condition of the patient is evaluated as a more urgent medical condition. The rest level indicates how much the medical condition of the patient necessitates rest. As the rest level is higher, it is evaluated that a patient has a medical condition that necessitates further rest. The route priority determination unit 14 determines a priority for each of the plurality of transport routes based on a comparison result between the urgency level and the rest level, the burden, and the required time. More specifically, when the urgency level is higher than the rest level, the route priority determination unit 14 sets the priority of the transport route in which a required time is shorter than the other transport routes to be higher. On the other hand, when the urgency level is lower than the rest level, that is, when the rest level is higher than the urgency level, the route priority determination unit 14 sets the priority of the transport route having a lower burden than the other transport routes to be higher.

The route priority determination unit 14 sets an allowable condition in the transport route for each rest level, and lowers the priority of the transport route that does not satisfy the allowable condition. For example, the route priority determination unit 14 sets an upper limit of acceleration of a transport vehicle in a sharp curve, a step, or a gradient (hereinafter referred to as gradient or the like) included in the transport route for each rest level. Then, the route priority determination unit 14 lowers the priority of the transport route including a gradient or the like exceeding the upper limit of the acceleration of the transport vehicle for each rest level.

The route priority determination unit 14 performs machine learning using past medical condition information of the patient and a determination history of the priority of the transport route. Then, the route priority determination unit 14 may determine the priority for each of the plurality of transport routes based on the medical condition information of the patient and a model trained by the machine learning.

The route priority determination unit 14 performs the machine learning using the past medical condition information of the patient and the history of the transport route actually selected by an emergency attendant (a transport history of the patient). The route priority determination unit 14 may determine the priority for each of the plurality of transport routes based on the medical condition information of the patient and the model trained by the machine learning.

The route presentation unit 15 presents at least one of the plurality of transport routes in accordance with the priority. For example, the route presentation unit 15 presents the searched transport route to the terminal 20 in association with the priority. At this time, the route presentation unit 15 may present the transport route searched for in a descending order of the priorities to the terminal 20.

The storage unit 16 stores the map information, the topographic information of the road, the weather information, the congestion information of the road, and the like acquired from an external apparatus at a predetermined interval.

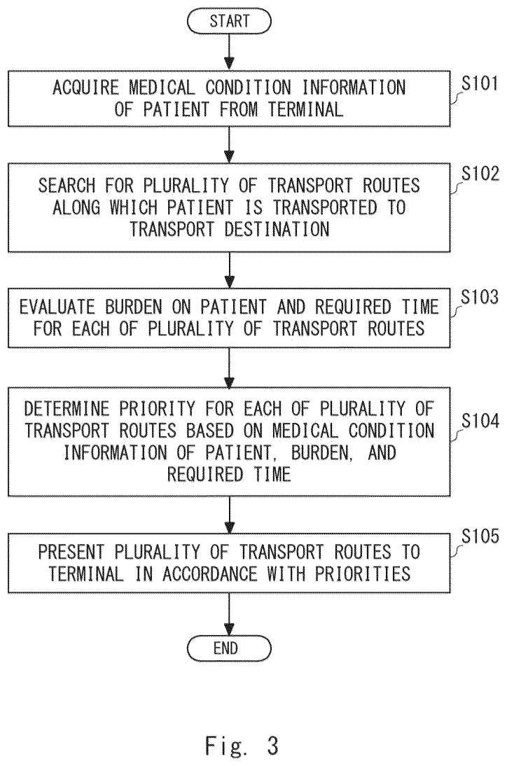

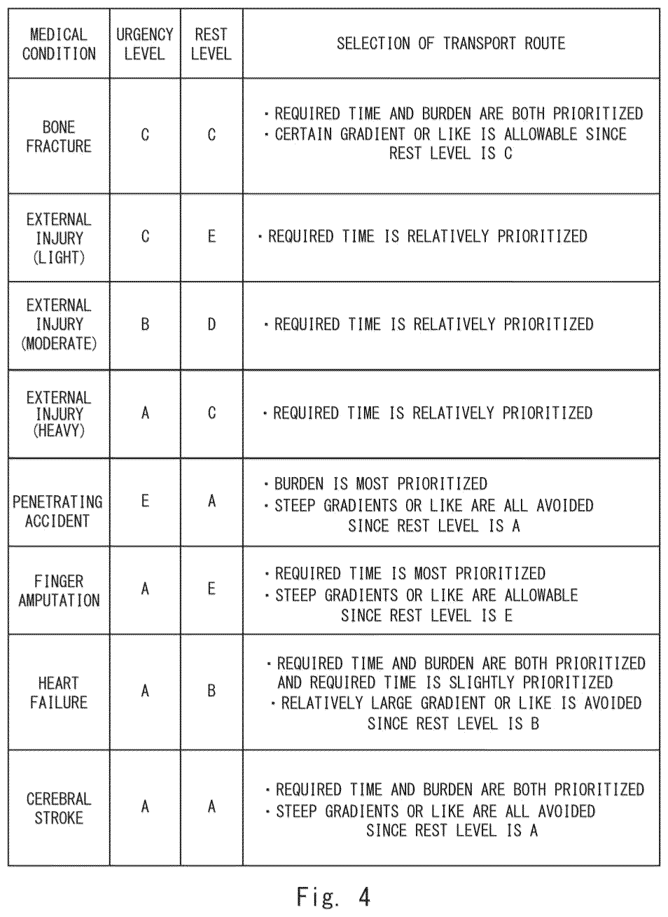

Next, an example of an operation of the transport route presentation apparatus 10 according to the second example embodiment will be described with reference to FIGS. 3 and 4.

First, an emergency attendant visits an emergency patient. Then, the emergency attendant inputs the medical condition information of the patient to the terminal 20. Then, the terminal 20 transmits the medical condition information of the patient to the transport route presentation apparatus 10.

The patient information acquisition unit 11 of the transport route presentation apparatus 10 acquires the medical condition information of the patient from the terminal 20 (step S101). The patient information acquisition unit 11 may acquire the medical condition information of the patient automatically determined based on a camera video.

Subsequently, the route search unit 12 searches for a plurality of transport routes along which the patient is transported to the transport destination (step S102). Specifically, the route search unit 12 searches for a plurality of transport routes along which the patient is transported to a transport destination based on current positional information of the patient and the map information. For example, the current positional information of the patient is obtained from the terminal 20. The current positional information is patient positional information directly input to the emergency attendant or the like, GPS information of the terminal 20, or the like. The map information is stored in advance in the storage unit 16.

Subsequently, the route evaluation unit 13 evaluates the burden on the patient and the required time for each of the searched transport routes (step S103). A time of arrival at the transport destination may be evaluated instead of the required time.

Specifically, the route evaluation unit 13 calculates a burden and a required time based on a distance from the transport source to the transport destination.

The route evaluation unit 13 also acquires the topographic information of the road from the storage unit 16. The topographic information of the road is information indicating a sharp curve, a step, a gradient, and the like on the road. For example, the topographic information of the road is information based on acceleration information of the vehicle acquired from the vehicle and positional information of the vehicle. The route evaluation unit 13 evaluates the burden and the required time for each of the transport routes based on latest topographic information of the road. For example, the route evaluation unit 13 evaluates that the more the route passes through a sharp curve, a step, or a gradient along the transport route, the larger the burden and the longer the required time are.

The route evaluation unit 13 also acquires the weather information from the storage unit 16. The route evaluation unit 13 evaluates the burden and the required time for each of the transport routes based on the latest weather information. For example, the route evaluation unit 13 evaluates that the worse the weather is, such as with heavy rain or snow, the higher the burden and the required time are.

The route evaluation unit 13 also acquires the congestion information of the road from the storage unit 16. The congestion information of the road is information based on at least one of imaging information acquired from an imaging apparatus installed on the road and information regarding a traffic light installed on the road. The route evaluation unit 13 evaluates the burden and the required time for each of the transport routes based on the latest congestion information of the road. For example, the route evaluation unit 13 evaluates that the heavier the road is, the longer the required time is.

Subsequently, the route priority determination unit 14 determines the priority for each of the transport routes searched for based on the medical condition information of the patient, the burden, and the required time (step S104).

Specifically, the route priority determination unit 14 evaluates the urgency level of the medical condition and the rest level from the medical condition information of the patient.

For example, as illustrated in FIG. 4, the route priority determination unit 14 evaluates the urgency level and the rest level in the medical condition of each patient. The route priority determination unit 14 evaluates the urgency level at five stages of A to E and the rest level at five stages of A to E. Here, the urgency level increases in order from E to A. The rest level increases in order from E to A. When the medical condition is a bone fracture, the urgency level is C and the rest level is C. When the medical condition is an external injury (light), the urgency level is C and the rest level is E. When the medical condition is an external injury (moderate), the urgency level is B and the rest level is D. When the medical condition is an external injury (heavy), the urgency level is A and the rest level is C. When the medical condition is a penetrating accident, the urgency level is E and the rest level is A. When the medical condition is a finger amputation, the urgency level is A and the rest level is E. When the medical condition is a heart failure, the urgency level is A and the rest level is B. When the medical condition is a cerebral stroke, the urgency level is A and the rest level is A.

The route priority determination unit 14 compares the urgency level with the rest level and determines the priority for each of the plurality of transport routes based on the comparison result between the urgency level and the rest level, the burden, and the required time.

Specifically, the route priority determination unit 14 determines whether the urgency level or the rest level is higher. Further, when the urgency level or the rest level is high, the route priority determination unit 14 determines how much difference there is between the urgency level and the rest level. When the urgency level is higher than the rest level, the route priority determination unit 14 sets the priority of the transport route having a shorter required time than the other transport routes to be higher. Here, the route priority determination unit 14 sets the priority of the transport route having a shorter required time to be higher as the difference between the urgency level and the rest level is larger. Conversely, when the urgency level is lower than the rest level, that is, when the rest level is higher than the urgency level, the route priority determination unit 14 sets the priority of the transport route having a lower burden than the other transport routes to be higher. Here, the route priority determination unit 14 sets the priority of the transport route having a lower burden as the difference between the urgency level and the rest level is larger. When the urgency level and the rest level are the same, the route priority determination unit 14 increases the priority of the transport route having a good balance between the low burden and the short required time.

Further, the route priority determination unit 14 sets an allowable condition in the transport route for each rest level and lowers the priority of the transport route that does not satisfy the allowable condition. For example, the route priority determination unit 14 sets the upper limit of an acceleration of the transport vehicle in a gradient or the like included in the transport route for each rest level. Then, the route priority determination unit 14 lowers the priority of the transport route including a gradient or the like exceeding the upper limit of the acceleration of the transport vehicle for each rest level.

For example, as illustrated in FIG. 4, the route priority determination unit 14 determines a priority for each of the plurality of transport routes based on the comparison result between the urgency level and the rest level, the burden, and the required time.

In the example of FIG. 4, the route priority determination unit 14 sets “slight priority” to either the urgency level or the rest level when the difference between the urgency level and the rest level is one level, sets “relative priority” when the difference is two levels, sets “priority” when the difference is three levels, and sets “most priority” when the difference is four levels. When the rest levels are A, B, C, D, and E, the route priority determination unit 14 sets an allowable condition such as a gradient in the transport route. That is, when the rest levels are A, B, C, D, and E, the route priority determination unit 14 sets the upper limits L1, L2, L3, L4, and L5 of the acceleration of the transport vehicle in the gradient or the like. In the order of the upper limits L1 to L5, the upper limit of the acceleration of the transport vehicle is higher.

When the medical condition is a bone fracture (the urgency level is C and rest level is C), the route priority determination unit 14 determines that the urgency level and the rest level are the same and increases the priority of the transport route having a good balance between the low burden and the short required time. When the medical condition is a bone fracture, the route priority determination unit 14 allows the transport route including a certain gradient or the like since the rest level is C. In other words, the route priority determination unit 14 lowers the priority of the transport route including the gradient or the like in which the acceleration of the transport vehicle exceeds the upper limit L3.

When the medical condition is an external injury (light) (the urgency level is C, and the rest level is E), the route priority determination unit 14 determines that the urgency level is two levels higher than the rest level, and determines the priority of the transport route so that the transport route having a short required time is relatively prioritized. When the medical condition is an external injury (moderate) (the urgency level is B and the rest level is D), the route priority determination unit 14 determines that the urgency level is two levels higher than the rest level, and determines the priority of the transport route so that the transport route having a short required time is relatively prioritized. When the medical condition is an external injury (heavy) (the urgency level is A and the rest level is C), the route priority determination unit 14 determines that the urgency level is two levels higher than the rest level, and determines the priority of the transport route so that the transport route having a short required time is relatively prioritized. Here, since the rest level for the external injury (light) to the external injury (heavy) increases, the route priority determination unit 14 avoids transport routes including steep gradients or the like.

When the medical condition is a penetrating accident (the urgency level is E and the rest level is A), the route priority determination unit 14 determines that the rest level is four levels higher than the urgency level, and determines the priority of the transport route so that a transport route having a low burden is most prioritized. Here, since the rest level is A, the route priority determination unit 14 avoids all the transport routes including steep gradients or the like. That is, the route priority determination unit 14 lowers the priority of the transport route including the gradient or the like in which the acceleration of the transport vehicle exceeds the upper limit L1.

When the medical condition is a finger amputation (the urgency level is A and the rest level is E), the route priority determination unit 14 determines that the urgency level is four levels higher than the rest level, and determines the priority of the transport route so that the transport route having a short required time is most prioritized. When the medical condition is the finger amputation, the route priority determination unit 14 allows the transport route including a steep gradient or the like since the rest level is E. That is, the route priority determination unit 14 lowers the priority of the transport route including the gradient or the like in which the acceleration of the transport vehicle exceeds the upper limit L5.

When the medical condition is heart failure (the urgency level is A and the rest level is B), the route priority determination unit 14 determines that the urgency level is one step higher than the rest level, and determines the priority of the transport route so that a transport route having a short required time is slightly prioritized. Here, since the rest level is B, the route priority determination unit 14 avoids the transport route including a relatively large gradient or the like. That is, the route priority determination unit 14 lowers the priority of the transport route including the gradient or the like in which the acceleration of the transport vehicle exceeds the upper limit L2.

When the medical condition is a cerebral stroke (the urgency level is A and the rest level is A), the route priority determination unit 14 determines that the urgency level and the rest level are the same, and increases the priority of the transport route having a good balance between the low burden and the short required time. Here, since the rest level is A, the route priority determination unit 14 avoids all the transport routes including steep gradients or the like. That is, the route priority determination unit 14 lowers the priority of the transport route including the gradient or the like in which the acceleration of the transport vehicle exceeds the upper limit L1.

In the above-described example, the urgency level and the rest level are evaluated as A, B, C, D, and E, but the urgency level and the rest level may be evaluated as numerical values of, for example, 0 to 100. At this time, the urgency level and the rest level may be divided into stages such as 0 to 20, 21 to 40, 41 to 60, 61 to 80, and 81 to 100.

The route priority determination unit 14 performs machine learning using past medical condition information of the patient and a determination history of the priority of the transport route. Then, the route priority determination unit 14 may determine the priority for each of the plurality of transport routes based on the medical condition information of the patient and a model trained by the machine learning.

When the patient is unconscious, the route priority determination unit 14 may determine the priority of the transport route with regard to an intention of the patient himself or herself stored in the storage unit 16 based on data.

The route priority determination unit 14 may set an allowable range of the burden for each rest level and lower the priority of the transport route in which the burden is out of the allowable range. The route priority determination unit 14 may set the allowable range of the burden for each medical condition and lower the priority of the transport route in which the burden is out of the allowable range.

The description returns to FIG. 3. Subsequently, the route presentation unit 15 presents the searched transport routes to the terminal 20 in accordance with the priorities (step S105). Specifically, the route presentation unit 15 presents the searched transport route to the terminal 20 in association with the priority. At this time, the route presentation unit 15 may present the transport route searched for in a descending order of the priorities to the terminal 20. The route presentation unit 15 may select at least one type of transport route having a high priority from the searched transport routes and present the selected transport route to the terminal 20. At this time, the route presentation unit 15 may present the transport route selected in a descending order of the priorities to the terminal 20. Here, the route presentation unit 15 may present the selected transport route to another terminal such as a terminal installed in a hospital without being limited to the terminal 20 used by the emergency attendant.

As described above, the transport route presentation apparatus 10 of the transport route presentation system 200 according to the second example embodiment can present a transport route in accordance with detailed symptoms of the patient (In the above-described example, a bone fracture, an external injury, a penetrating accident, and the like). For example, the transport route presentation apparatus 10 can prioritize not only a transport route in which a burden on the patient during transport is small depending on the symptoms of the patient, but also a transport route in which a time required for transport is short.

The transport route presentation apparatus 10 evaluates the urgency level and the rest level for the medical condition of the patient, and determines the priority for each of the plurality of transport routes based on a comparison result between the urgency level and the rest level and the burden and the required time. Accordingly, the transport route presentation apparatus 10 can present the transport route in accordance with the medical condition of the patient.

The transport route presentation apparatus 10 acquires topographic information of the road, weather information, congestion information of the road, and the like at predetermined intervals, and evaluates the burden and the required time based on these pieces of information. Accordingly, the transport route presentation apparatus 10 can improve the accuracy of the evaluation of the transport route by using various information regarding the transport route in real time, and can present the transport route in accordance with the medical condition of the patient.

The transport route presentation apparatus 10 determines the priority of the transport route using the machine learning. Accordingly, the transport route presentation apparatus 10 can improve accuracy of the determination of the priority of the transport route and present the transport route in accordance with the medical condition of the patient.

The present invention is not limited to the above example embodiments, and can be appropriately changed without departing from the gist.

### Example of Hardware Configuration

Each functional constituent unit of the transport route presentation apparatus 10 according to the first and second example embodiments may be realized by hardware (for example, a hard-wired electronic circuit or the like) that realizes each functional constituent unit or may be realized by combining hardware and software (for example, a combination of an electronic circuit and a program that controls the electronic circuit or the like). Hereinafter, a case where each functional constituent unit of the above apparatus is realized by combining hardware and software will be further described.

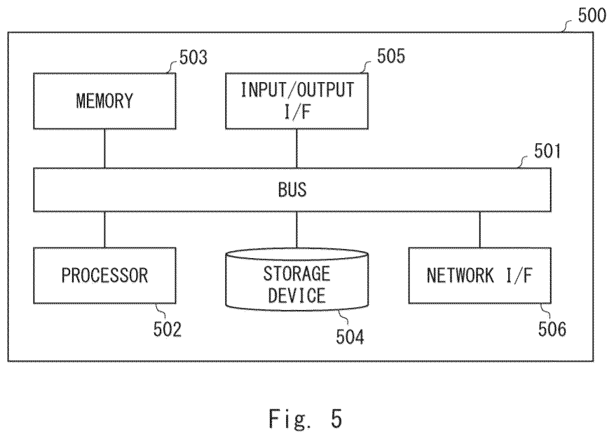

FIG. 5 is a block diagram illustrating a hardware configuration of a computer 500. The transport route presentation apparatus 10 can be realized by the computer 500. The computer 500 may be a portable computer such as a smartphone or a tablet terminal or may be a stationary computer such as a PC. The computer 500 may be a dedicated computer or a general-purpose computer.

For example, by installing a predetermined application on the computer 500, the computer 500 can have a desired function. For example, by installing an application for realizing each function of the transport route presentation apparatus 10 in the computer 500, each function of the transport route presentation apparatus 10 is realized in the computer 500.

The computer 500 includes a bus 501, a processor 502, a memory 503, a storage device 504, an input/output interface (I/F) 505, and a network interface (I/F) 506. The bus 501 is a data transmission path along which the processor 502, the memory 503, the storage device 504, the input/output interface 505, and the network interface 506 transmit and receive data to and from each other. However, a method of connecting the processor 502 and the like to each other is not limited to connection by the bus.

The processor 502 is any of various processors such as a central processing unit (CPU), a graphics processing unit (GPU), or a field-programmable gate array (FPGA). The memory 503 is a main storage device realized by using a random access memory (RAM) or the like. The storage device 504 is an auxiliary storage device realized by using a hard disk, a solid state drive (SSD), a memory card, a read only memory (ROM), or the like.

The input/output interface 505 is an interface connecting the computer 500 to an input/output device. For example, an input device such as a keyboard and an output device such as a display device are connected to the input/output interface 505.

The network interface 506 is an interface connecting the computer 500 to a network. The network may be a local area network (LAN) or a wide area network (WAN).

The storage device 504 stores a program that realizes a desired function. For example, the storage device 504 included in the computer 500 realizing the transport route presentation apparatus 10 stores a program (a program of the above-described application that realizes a function of the transport route presentation apparatus 10) realizing the function of the transport route presentation apparatus 10. The processor 502 reads the program into the memory 503 and executes the program to realize each function.

The programs include a command group (or software codes) causing the computer to perform one or more functions that have been described in the example embodiments when the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technique, a CD-ROM, a digital versatile disc (DVD), a Blu-ray (registered trademark) disc or any other optical disk storage, a magnetic cassette, a magnetic tape, a magnetic disk storage, and any other magnetic storage devices. The program may be transmitted on a transitory computer-readable medium or a communication medium. As an example and not by way of limitation, transitory computer-readable or communication media include electrical, optical, acoustic, or other forms of propagated signals.

Some or all of the above-described example embodiments may be described as in the following supplementary notes, but are not limited to the following supplementary notes.

### Supplementary Note 1

A transport route presentation apparatus including:
a patient information acquisition unit configured to acquire medical condition information of a patient;
a route search unit configured to search for a plurality of transport routes along which the patient is transported to a transport destination;
a route evaluation unit configured to evaluate a burden on a patient and a required time for each of the plurality of transport routes;
a route priority determination unit configured to determine a priority for each of the plurality of transport routes based on the medical condition information of the patient, the burden, and the required time; and
a route presentation unit configured to present at least one of the plurality of transport routes in accordance with the priority.

### Supplementary Note 2

The transport route presentation apparatus according to Supplementary Note 1, wherein the route priority determination unit
evaluates an urgency level and a rest level of a medical condition based on the medical condition information of the patient, and
determines a priority for each of the plurality of transport routes based on a comparison result between the urgency level and the rest level, the burden, and the required time.

### Supplementary Note 3

The transport route presentation apparatus according to Supplementary Note 2, wherein the route priority determination unit
sets a priority of a transport route having a shorter required time than other transport routes to be higher when the urgency level is higher than the rest level, and
sets a priority of a transport route having a lower burden than other transport routes to be higher when the urgency level is lower than the rest level.

### Supplementary Note 4

The transport route presentation apparatus according to Supplementary Note 2 or 3, wherein the route priority determination unit
sets an allowable condition in the transport route for each rest level, and
sets a priority of a transport route that does not satisfy the allowable condition to be lower.

### Supplementary Note 5

The transport route presentation apparatus according to any one of Supplementary Notes 1 to 4, wherein the route evaluation unit evaluates the burden and the required time for each of the transport routes based on topographic information of a road acquired at a predetermined interval.

### Supplementary Note 6

The transport route presentation apparatus according to Supplementary Note 5, wherein the topographic information of the road is information based on acceleration information of a vehicle and positional information of the vehicle acquired from the vehicle.

### Supplementary Note 7

The transport route presentation apparatus according to any one of Supplementary Notes 1 to 4, wherein the route evaluation unit evaluates the burden and the required time for each of the transport routes based on weather information acquired at a predetermined interval.

### Supplementary Note 8

The transport route presentation apparatus according to any one of Supplementary Notes 1 to 4, wherein the route evaluation unit evaluates the burden and the required time for each of the transport routes based on congestion information of a road acquired at a predetermined interval.

### Supplementary Note 9

The transport route presentation apparatus according to Supplementary Note 8, wherein the congestion information of the road is information based on at least one of imaging information acquired from an imaging apparatus installed on a road and information regarding a traffic light installed on the road.

### Supplementary Note 10

The transport route presentation apparatus according to any one of Supplementary Notes 1 to 9, wherein the route priority determination unit
performs machine learning using past medical condition information of a patient and a determination history of the priorities of the transport routes, and
determines a priority for each of the plurality of transport routes based on the medical condition information of the patient and a model trained by the machine learning.

### Supplementary Note 11

The transport route presentation apparatus according to any one of Supplementary Notes 1 to 10, wherein the route priority determination unit
performs machine learning using past medical condition information of a patient and a transport history of the patient, and
determines a priority for each of the plurality of transport routes based on the medical condition information of the patient and a model trained by the machine learning.

### Supplementary Note 12

A transport route presentation method causing a computer to perform:
acquiring medical condition information of a patient;
searching for a plurality of transport routes along which the patient is transported to a transport destination;
evaluating a burden on a patient and a required time for each of the plurality of transport routes;
determining a priority for each of the plurality of transport routes based on the medical condition information of the patient, the burden, and the required time; and
presenting at least one of the plurality of transport routes in accordance with the priority.

### Supplementary Note 13

A non-transitory computer-readable medium that stores a program causing a computer to perform:
acquiring medical condition information of a patient;
searching for a plurality of transport routes along which the patient is transported to a transport destination;
evaluating a burden on a patient and a required time for each of the plurality of transport routes;
determining a priority for each of the plurality of transport routes based on the medical condition information of the patient, the burden, and the required time; and
presenting at least one of the plurality of transport routes in accordance with the priority.

### REFERENCE SIGNS LIST

10 TRANSPORT ROUTE PRESENTATION APPARATUS

11 PATIENT INFORMATION ACQUISITION UNIT

12 ROUTE SEARCH UNIT

13 ROUTE EVALUATION UNIT

14 ROUTE PRIORITY DETERMINATION UNIT

15 ROUTE PRESENTATION UNIT

16 STORAGE UNIT

20 TERMINAL

200 TRANSPORT ROUTE PRESENTATION SYSTEM

500 COMPUTER

501 BUS

502 PROCESSOR

503 MEMORY

504 STORAGE DEVICE

505 INPUT/OUTPUT INTERFACE (I/F)

506 NETWORK INTERFACE (I/F)

What is claimed is:

1. A transport route presentation apparatus comprising:
at least one memory storing instructions, and
at least one processor configured to execute the instructions to:
acquire medical condition information of a patient;
search for a plurality of transport routes along which the patient is transported to a transport destination;
evaluate a burden on a patient and a required time for each of the plurality of transport routes;
determine a priority for each of the plurality of transport routes based on the medical condition information of the patient, the burden, and the required time; and
present at least one of the plurality of transport routes in accordance with the priority.

2. The transport route presentation apparatus according to claim 1, wherein the at least one processor is further configured to execute the instructions to:
evaluate an urgency level and a rest level of a medical condition based on the medical condition information of the patient; and
determine a priority for each of the plurality of transport routes based on a comparison result between the urgency level and the rest level, the burden, and the required time.

3. The transport route presentation apparatus according to claim 2, wherein the at least one processor is further configured to execute the instructions to:
set a priority of a transport route having a shorter required time than other transport routes to be higher when the urgency level is higher than the rest level; and
set a priority of a transport route having a lower burden than other transport routes to be higher when the urgency level is lower than the rest level.

4. The transport route presentation apparatus according to claim 2, wherein the at least one processor is further configured to execute the instructions to:
set an allowable condition in the transport route for each rest level; and
set a priority of a transport route that does not satisfy the allowable condition to be lower.

5. The transport route presentation apparatus according to claim 4, wherein the at least one processor is further configured to execute the instructions to evaluate the burden and the required time for each of the transport routes based on topographic information of a road acquired at a predetermined interval.

6. The transport route presentation apparatus according to claim 5, wherein the topographic information of the road is information based on acceleration information of a vehicle and positional information of the vehicle acquired from the vehicle.

7. The transport route presentation apparatus according to claim 4, wherein the at least one processor is further configured to execute the instructions to evaluate the burden and the required time for each of the transport routes based on weather information acquired at a predetermined interval.

8. The transport route presentation apparatus according to claim 4, wherein the at least one processor is further configured to execute the instructions to evaluate the burden and the required time for each of the transport routes based on congestion information of a road acquired at a predetermined interval.

9. The transport route presentation apparatus according to claim 8, wherein the congestion information of the road is information based on at least one of imaging information acquired from an imaging apparatus installed on a road and information regarding a traffic light installed on the road.

10. The transport route presentation apparatus according to claim 1, wherein the at least one processor is further configured to execute the instructions to:
perform machine learning using past medical condition information of a patient and a determination history of the priorities of the transport routes; and
determine a priority for each of the plurality of transport routes based on the medical condition information of the patient and a model trained by the machine learning.

11. The transport route presentation apparatus according to claim 1, wherein the at least one processor is further configured to execute the instructions to:
perform machine learning using past medical condition information of a patient and a transport history of the patient; and
determine a priority for each of the plurality of transport routes based on the medical condition information of the patient and a model trained by the machine learning.

12. A transport route presentation method causing a computer to perform:
acquiring medical condition information of a patient;
searching for a plurality of transport routes along which the patient is transported to a transport destination;
evaluating a burden on a patient and a required time for each of the plurality of transport routes;
determining a priority for each of the plurality of transport routes based on the medical condition information of the patient, the burden, and the required time; and
presenting at least one of the plurality of transport routes in accordance with the priority.

13. A non-transitory computer-readable medium that stores a program causing a computer to perform:
acquiring medical condition information of a patient;
searching for a plurality of transport routes along which the patient is transported to a transport destination;
evaluating a burden on a patient and a required time for each of the plurality of transport routes;
determining a priority for each of the plurality of transport routes based on the medical condition information of the patient, the burden, and the required time; and
presenting at least one of the plurality of transport routes in accordance with the priority.
